(19) United States
(12) Patent Application Publication
(10) Pub. No.: US 2015/0255775 A1
(43) Pub. Date: Sep. 10, 2015

(54) STEPWISE ELECTRODE ASSEMBLY INCLUDING ONE-SIDED NEGATIVE ELECTRODE

(71) Applicant: LG CHEM, LTD., Seoul (KR)

(72) Inventors: Sung-Jin Kwon, Daejeon (KR); Dong-Myung Kim, Daejeon (KR); Ki-Woong Kim, Daejeon (KR); Soon-Ho Ahn, Seoul (KR)

(73) Assignee: LG Chem, Ltd., Seoul (KR)

(21) Appl. No.: 14/433,784

(22) PCT Filed: Mar. 15, 2013
(86) PCT No.: PCT/KR2013/002146

§ 371 Date: Apr. 6, 2015

Related U.S. Application Data
(60) Provisional application No. 61/725,718, filed on Nov. 13, 2012.

(30) Foreign Application Priority Data
Feb. 8, 2013 (KR) 10-2013-0014718
Mar. 15, 2013 (KR) 10-2013-0028326

(51) Int. Cl. H01M 2/22

(52) U.S. Cl. CPC H01M 2/22; H01M 2004/021

(57) ABSTRACT

An electrode assembly includes at least one positive electrode coated with a positive electrode active material on both surfaces of a positive electrode current collector and at least one negative electrode coated with a negative electrode active material on both surfaces of a negative electrode current collector are alternately stacked in a direction perpendicular to a plane by placing a separation film therebetween. The electrode assembly includes a stepped part formed by placing a second electrode which has a different pole and a different area from those of a first electrode on the first electrode. At least one of outermost electrodes located on both surfaces of the electrode assembly is a one-side coated negative electrode, which has a surface coated with the negative electrode active material, and another surface as a non-coated portion. The non-coated portion is arranged in order to face the outside of the electrode assembly.

### TECHNICAL FIELD

The present invention relates to a stepwise electrode assembly, and more particularly, to an electrode assembly having enhanced design flexibility in a stacking width direction thereof.

### BACKGROUND ART

Stepwise electrode assemblies have a structure as illustrated in FIG. 1. An electrode assembly 1, as such a stepwise electrode assembly, includes positive electrodes 11 or negative electrodes 13 as outermost electrodes on both surfaces thereof.

When the outermost electrodes are the positive electrodes 11, the positive electrodes 11 are one-side coated positive electrodes in which a positive electrode active material is applied to only one surface of a positive electrode current collector and is not applied to another surface thereof, thereby ensuring battery safety against reduction of lithium. When the outermost electrodes are the negative electrodes 13 as illustrated in FIG. 3, the negative electrodes 13 are double-side coated negative electrodes including negative electrode active material layers 5 formed by applying a negative electrode active material to both surfaces of a negative electrode current collector 3, as illustrated in FIG. 2.

However, a double-side coated negative electrode 13 as illustrated in FIG. 2 is disposed as an outermost electrode of an electrode assembly 1, the thickness of a battery is increased by the thickness of negative electrode active material layers 5 formed by applying an electrode active material to both surfaces of a negative electrode current collector 3, thereby reducing the flexibility of the shape of the electrode assembly 1 in the thickness direction thereof.

In addition, since the electrode active material applied to a surface of the negative electrode 13 disposed as the outermost electrode of the electrode assembly 1 does not affect battery capacity, the battery capacity is not increased by the thickness of the negative electrode active material layer 5 on the surface of the negative electrode 13, thereby reducing battery capacity per unit volume. Furthermore, since a negative electrode active material as the electrode active material is applied to both the surfaces of the negative electrode current collector 3 although the negative electrode active material does not affect the battery capacity, a use amount of the negative electrode active material is increased to cause economic losses.

Thus, improvements for increasing the battery capacity per unit volume, decreasing the use amount of the negative electrode active material, and increasing the flexibility of the shape of the electrode assembly 1 in the thickness direction thereof are needed.

### DISCLOSURE OF THE INVENTION

### Technical Problem

Accordingly, the present invention aims at providing an electrode assembly, which includes a one-side coated negative electrode, instead of a conventional double-side coated negative electrode, as an outermost electrode of the electrode assembly, thereby increasing battery capacity per unit volume, decreasing a use amount of an electrode active material, and increasing the flexibility of the shape of the electrode assembly in the thickness direction thereof.

### Technical Solution

According to an aspect of the present invention, there is provided an electrode assembly including: at least one positive electrode coated with a positive electrode active material on both surfaces of a positive electrode current collector; and at least one negative electrode coated with a negative electrode active material on both surfaces of a negative electrode current collector, wherein the at least one positive electrode and the at least one negative electrode are alternately stacked in a direction perpendicular to a plane by placing a separation film between the positive electrode and the negative electrode, the electrode assembly includes a stepped part formed by placing a second electrode, which has a different pole and a different area from those of a first electrode, on the first electrode, at least one of outermost electrodes located on both surfaces of the electrode assembly is a one-side coated negative electrode, which has a surface coated with the negative electrode active material, and another surface as a non-coated portion, and the non-coated portion is arranged in order to face the outside of the electrode assembly.

One of the first and second electrodes, which has a greater area than that of the other, may be the negative electrode.

The electrode assembly may include two or more electrode units having different areas. The electrode units may be constituted by at least one selected from the group consisting of a single electrode; at least one unit cell including at least one positive electrode, at least one negative electrode, and at least one separation film; and a combination thereof. The unit cell may be selected from the group consisting of a jelly-roll type unit cell, a stack type unit cell, a lamination and stack type unit cell, and a stack and folding type unit cell. Two electrodes disposed on both outermost surfaces of the unit cell may have the same pole or different poles.

The electrode assembly may have a structure in which at least one part of the single electrode and the unit cell, which constitute the electrode units, is surrounded by at least one long sheet type separation film.

The electrode units may include at least one electrode tab. Each of the electrode tabs may be electrically connected to electrodes having the same pole. The electrode tabs may have the same size or different sizes according to the areas of the electrode units.

An outermost electrode of the electrode assembly may be a one-side coated positive electrode that has a surface coated with the positive electrode active material, and another surface as a non-coated portion, and the non-coated portion may be arranged in order to face the outside of the electrode assembly.

Electrodes may be stacked such that areas of the electrodes increase or decrease in the direction perpendicular to the plane, so as to form a stepped part.

According to another aspect of the present invention, there is provided a secondary battery including the electrode assembly. The electrode assembly may be installed in a battery case. The battery case may be a pouch type case. The secondary battery may be a lithium ion secondary battery or a lithium ion polymer secondary battery

According to another aspect of the present invention, there is provided a battery pack including the secondary battery at least in duplicate.

According to another aspect of the present invention, there is provided a device including the secondary battery or the secondary battery at least in duplicate. The device may be a cellular phone, a portable computer, a smart phone, a smart pad, a netbook, a light electronic vehicle (LEV), an electric vehicle, a hybrid electric vehicle, a plug-in hybrid electric vehicle, or a power storage device.

### Advantageous Effects

According to the present invention, when a negative electrode is disposed as an outermost electrode of an electrode assembly, a one-side coated negative electrode is used, in which only one surface of a negative electrode current collector is coated with a negative electrode active material, thereby economically decreasing a use amount of a negative electrode active material, and increasing battery capacity per unit volume.

Furthermore, the thickness of the electrode assembly can be decreased by the thickness of an electrode active material layer, thereby increasing the flexibility of the shape of the electrode assembly in the thickness direction thereof.

### BRIEF DESCRIPTION OF THE DRAWINGS

FIG. 1 is a perspective view schematically illustrating a stepwise electrode assembly;

FIG. 2 is a cross-sectional view schematically illustrating a negative electrode including an electrode active material applied to both surfaces of a negative electrode current collector;

FIG. 3 is a cross-sectional view schematically illustrating a stepwise electrode assembly in which double-side coated negative electrodes as illustrated in FIG. 2 are used as outermost electrodes on both surfaces of the stepwise electrode assembly;

FIGS. 4 to 6 are cross-sectional views schematically illustrating an electrode assembly in which one-side coated negative electrodes are used as outermost electrodes on both surfaces of the electrode assembly, according to an embodiment of the present invention;

FIG. 7 is a cross-sectional view schematically illustrating a one-side coated negative electrode including a negative electrode active material applied to only one surface of a negative electrode current collector, according to the present invention; and

FIGS. 8 to 10 are views illustrating lamination and stack type unit cells according to embodiments of the present invention.

### BEST MODE FOR CARRYING OUT THE INVENTION

The inventors of the present invention have continually researched an electrode assembly having enhanced shape flexibility in the thickness direction thereof, and have finally found that the flexibility of the shape of an electrode assembly can be enhanced by using a one-side coated negative electrode, which is a negative electrode disposed on an outermost side of the electrode assembly, and only one surface of which is coated with an electrode active material, thereby completing the present invention.

Preferred embodiments of the present invention will be described below with reference to the accompanying drawings. The invention may, however, be embodied in many different forms and should not be construed as being limited to the embodiments set forth herein. In addition, these embodiments are provided so that this disclosure will be thorough and complete, and will fully convey the concept of the invention to those skilled in the art. The shape and size of elements in the drawings may be exaggerated for clarity.

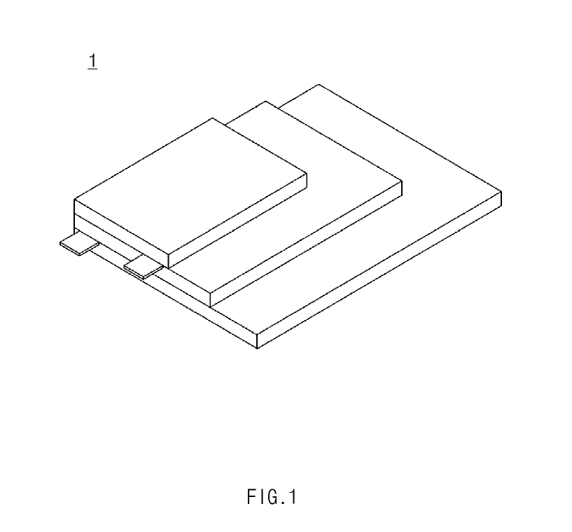

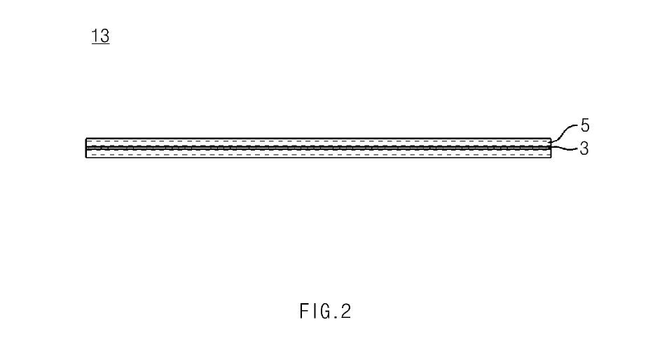

Referring to FIG. 1, an electrode assembly 1 is formed by alternately stacking at least one positive electrode 11 and at least one negative electrode 13 in a direction perpendicular to a plane with a separation film 19 between the positive electrode 11 and the negative electrode 13. The positive electrode 11 is coated with a positive electrode active material on both surfaces of a positive electrode current collector, and the negative electrode 13 includes negative electrode active material layers 5 formed by coating both surfaces of a negative electrode current collector 3 with a negative electrode active material. The electrode assembly 1 includes a stepped part formed by placing a second electrode, which has a different pole and a different area from those of a first electrode, on the first electrode.

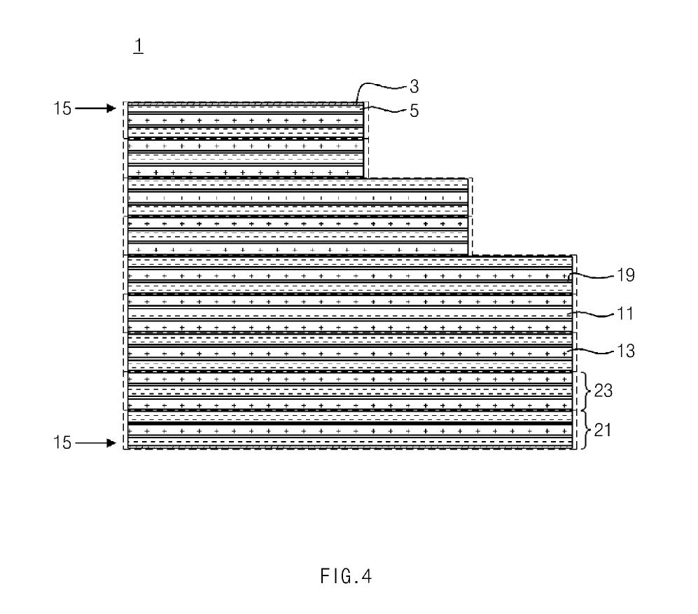

Referring to FIGS. 4 to 6, the negative electrode 13 and the positive electrode 11 may face each other with the separation film 19 therebetween at a border part provided with the stepped part. Since the negative electrode 13 and the positive electrode 11 may face each other as described above, even the border part can be used to increase battery capacity.

Referring to FIGS. 4 to 6, an electrode having a relatively large area may be disposed as the negative electrode 13 at the border part provided with the stepped part. Since the positive electrode 11 includes lithium as a positive electrode active material, if the positive electrode 11 is disposed as an electrode having a large area, lithium as a positive electrode active material may be educed from the positive electrode 11 during charging and discharging of a battery, which can decreases battery safety. Thus, the negative electrode 13 may be disposed as an electrode having a large area, thereby ensuring the battery safety.

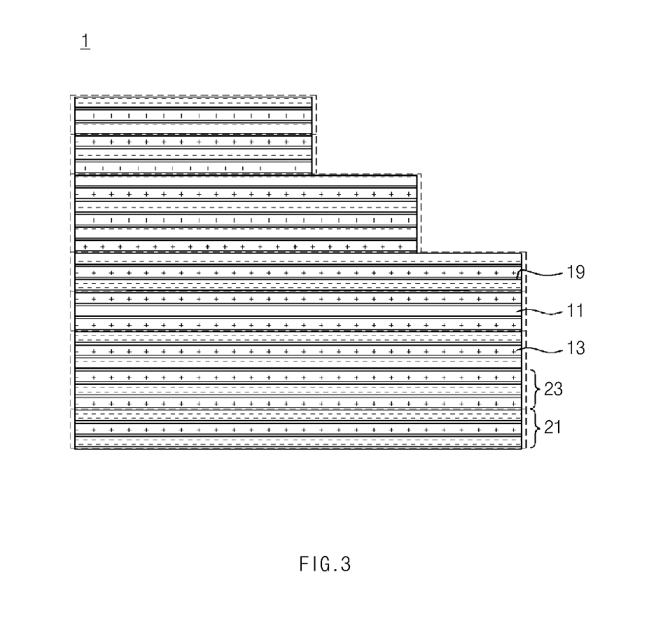

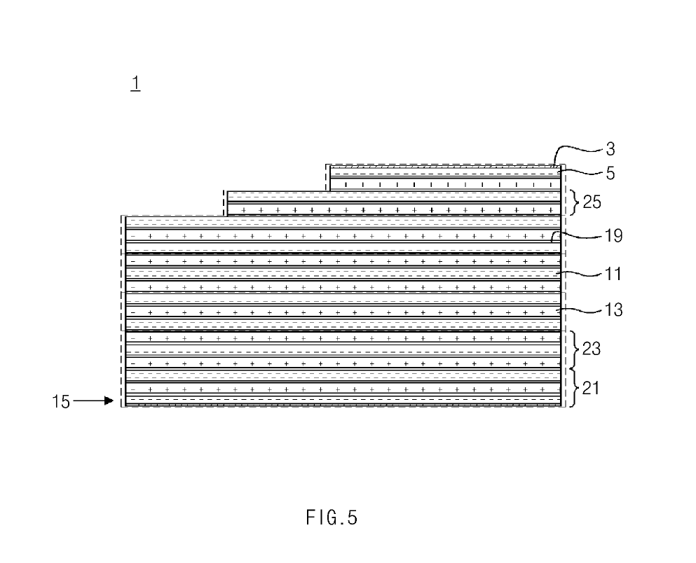

Referring to FIGS. 4 to 6, the negative electrode 13 may be disposed as an outermost electrode of the electrode assembly 1 because of the same reason as described above. FIG. 4 is a view illustrating an electrode assembly 1 including bi-cells 21 and 23 according to an embodiment. FIG. 5 is a view illustrating an electrode-stacked body in the lowest layer, which is formed by stacking bi-cells 21 and 23, and an electrode-stacked body in a second or greater layer which is formed using a mono-cell 25, according to an embodiment. When FIGS. 3 and 4 are compared with each other, the thickness of an electrode assembly as illustrated in FIG. 4 can be decreased by the thickness of a negative electrode active material layer 5, thereby further enhancing the flexibility of the shape of the electrode assembly.

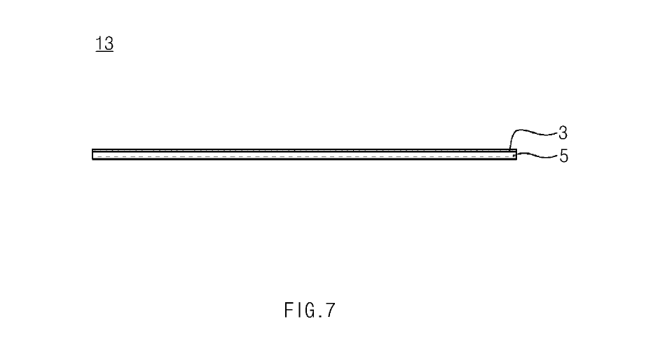

Referring to FIGS. 4 to 6, a negative electrode 13 disposed on an outermost side of the electrode assembly 1 may be a one-side coated negative electrode 15 as illustrated in FIG. 7. The one-side coated negative electrode 15 includes: a negative electrode active material layer 5, which is formed by applying a negative electrode active material on only one surface of a negative electrode current collector 3; and a non-coated portion, which is not coated with the negative electrode active material, on another surface of the negative electrode current collector 3. In this case, the negative electrode active material layer 5 faces a positive electrode active material layer of the positive electrode 11 toward a stacking surface of the electrode assembly 1 with a separation film 19 between the negative electrode active material layer 5 and the positive electrode active material layer, and the non-coated portion is directed to the outside of the electrode assembly 1.

Since an outer surface of an outermost electrode disposed on an outermost side of an electrode assembly is not employed in charge and discharge reactions of a battery, even though the one-side coated negative electrode 15 is used as an outermost electrode of the electrode assembly 1, the one-side coated negative electrode 15 does not affect the battery capacity.

Furthermore, since the one-side coated negative electrode 15 is used as an outermost electrode of the electrode assembly 1, the thickness of the electrode assembly is decreased by the thickness of the negative electrode active material applied to the negative electrode current collector 3. For example, when the one-side coated negative electrode 15 is used as the negative electrode 13 disposed on a surface of the electrode assembly 1, the thickness of the electrode assembly 1 may be decreased by [(thickness of double-side coated negative electrode−thickness of negative electrode current collector)/2]. Thus, the one-side coated negative electrode 15 may be superior to that of a double-side coated negative electrode 13, in terms of flexibility of the shape of an electrode assembly in the thickness direction thereof.

In addition, with the miniaturization and precision of recent devices that employ a secondary battery, accurate control of the shapes of secondary batteries and strict dimensional accuracy of secondary batteries in the thickness directions thereof are required. Thus, the flexibility of the shape of the electrode assembly 1 can be ensured to more reliably correspond to dimensional accuracy of the electrode assembly 1 required in the thickness direction thereof.

Specifically, when the thickness of each of electrode-stacked bodies of the electrode assembly 1 having the stepped part is limited to a specific value according to the shape of a device that employs a secondary battery, the electrode assembly 1 can more effectively correspond to the shape of the device by using the one-side coated negative electrode 15.

In the related art, when a positive electrode 11 is disposed as an outermost electrode of an electrode assembly 1, a one-side coated positive electrode including a positive electrode active material applied to only one surface of a positive electrode current collector is used. However, this configuration just ensures the battery safety against eduction of lithium from the positive electrode active material during charging and discharging of a battery, and does not ensure the flexibility of the shape of the electrode assembly 1 in the thickness direction thereof.

The one-side coated negative electrode 15 is not specifically delimited, provided that the negative electrode active material is applied to only one surface of the negative electrode current collector 3. Thus, commonly used active materials may be used as the negative electrode active material applied to one surface of the negative electrode current collector 3.

For example, the negative electrode current collector 3 may be formed of copper, nickel, aluminum, or a combination thereof, but the present invention is not limited thereto. In addition, for example, the negative electrode active material applied to one surface of the negative electrode current collector 3 may be one or more types of materials selected from a lithium metal, a lithium alloy, carbon, petmleum coke, activated carbon, graphite, a silicon compound, a stannum compound, a titanium compound, or an alloy thereof, but the present invention is not limited thereto.

A negative electrode 13 may be disposed on both surfaces of an electrode assembly 1 according to the present invention or one surface thereof, according to stacked forms. In this case, the one-side coated negative electrode 15 may be disposed on one surface of the electrode assembly 1, and the double-side coated negative electrode 13 may be disposed on another surface thereof, according to a required shape of the electrode assembly 1. Alternatively, the one-side coated negative electrode 15 may be disposed on both the surfaces of the electrode assembly 1 as illustrated in FIGS. 4 to 6. When a negative electrode 13 is disposed on one surface of an electrode assembly 1, and a positive electrode 11 is disposed on another surface thereof, the negative electrode 13 and the positive electrode 11 as outermost electrodes may be one-side coated electrodes.

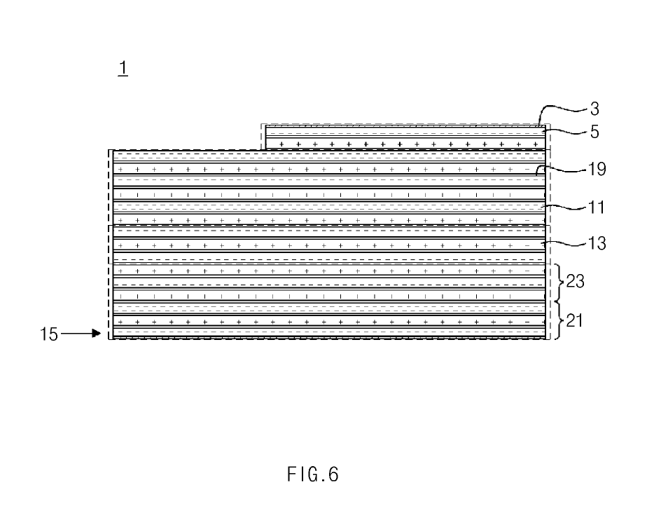

The number of stepped parts of an electrode assembly 1 according to the present invention is not specifically delimited. For example, an electrode assembly 1 according to the present invention may have three stepped parts as illustrated in FIGS. 4 and 5, or two stepped parts as illustrated in FIG. 6. According to the present invention, an electrode structure constituting a stepped part of an electrode assembly may be referred to as an electrode unit, for convenience in description. That is, the “electrode unit” denotes a basic unit constituting a stepped part of a stepwise electrode assembly according to the present invention. An electrode assembly 1 according to the present invention may be constituted by two types of electrode units having different areas as illustrated in FIG. 6, or three types of electrode units having different areas as illustrated in FIGS. 4 and 5. Alternatively, although not shown, an electrode assembly according to the present invention may include four or more types of electrode units.

Each of the electrode units may include a single electrode such as a negative electrode or a positive electrode; at least one unit cell including at least one negative electrode, at least one positive electrode, and at least one separation film; or a combination thereof.

The term “a unit cell” means a concept including all electrode-stacked bodies including at least one negative electrode, at least one positive electrode, and at least one separation film, and a method of stacking a negative electrode, a positive electrode, and a separation film in a unit cell is not specifically delimited. For example, according to the present invention, the term “a unit cell” means a concept including: an electrode-stacked body manufactured in a jelly-roll manner in which a sheet type negative electrode and a sheet type positive electrode are separated by a separation film and are then wound into a spiral shape; an electrode-stacked body manufactured in a stack manner in which at least one negative electrode, at least one separation film, and at least one positive electrode are sequentially stacked; and electrode stacked bodies manufactured in a stack and folding manner in which electrode-stacked bodies formed by stacking a single electrode and/or at least one positive electrode, a separation film, and positive electrodes are disposed on a long sheet type separation film, and then, the long sheet type separation film is folded.

Referring to FIG. 5, outermost electrodes disposed on both surfaces of the unit cells may have the same pole (refer to reference numerals 21 and 23), as in a structure of a positive electrode/a separation film/a negative electrode/a separation film/a positive electrode or a structure of a negative electrode/a separation film/a positive electrode/a separation film/a negative electrode, or the outermost electrodes may have opposite poles (refer to a reference numeral 25), as in a structure of a positive electrode/a separation film/a negative electrode or a structure of a positive electrode/a separation film/a negative electrode/a separation film/a positive electrode/a separation film/a negative electrode.

Electrode-stacked bodies manufactured in the stack manner include not only an electrode-stacked body manufactured in a conventional manner in which a positive electrode, a separation film, and a negative electrode are sequentially stacked one by one, but also an electrode-stacked body manufactured in a manner in which one or more positive electrodes, one or more negative electrodes, and one or more separation films are formed into electrode unit bodies through lamination, and then, the electrode unit bodies are stacked (hereinafter, referred to as “a lamination and stack manner”).

When the electrode-stacked body is manufactured in the lamination and stack manner, the configuration of the electrode unit bodies is not specifically delimited, provided that the electrode unit bodies include one or more positive electrodes, one or more negative electrodes, and one or more separation films.

However, when an electrode-stacked body is manufactured in the lamination and stack manner, an electrode unit body may include a basic structure of a first electrode/a separation film/a second electrode/a separation film or a basic structure of a separation film/a first electrode/a separation film/a second electrode, in view of simplicity and economic feasibility of processes. In this case, the first and second electrodes may have different poles and be a positive electrode or a negative electrode, and the electrode unit body may include one or more basic structures.

The electrode-stacked body manufactured in the lamination and stack manner may include only the electrode unit body including the basic structure, or a combination of the electrode unit body and an electrode structure including a structure different from that of the electrode unit body.

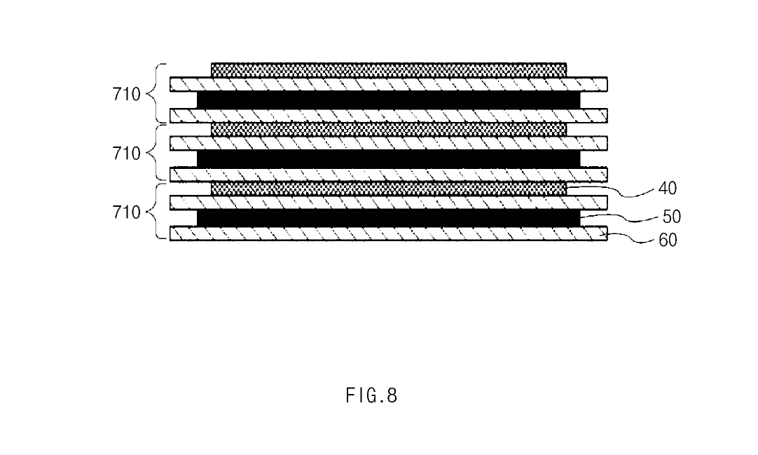

FIGS. 8 to 10 are views illustrating electrode-stacked bodies manufactured in the lamination and stack manner, according to various embodiments.

Referring to FIG. 8, an electrode-stacked body constituted by electrode unit bodies 710 having a basic structure of a separation film 60/a negative electrode 50/a separation film 60/a positive electrode 40 is manufactured in the lamination and stack manner. Although the basic structure illustrated in FIG. 8 is constituted by a separation film/a negative electrode/a separation film/a positive electrode, the basic structure may be constituted by a separation film/a positive electrode/a separation film/a negative electrode by replacing the positive electrode and the negative electrode with each other. When a basic structure of an electrode unit body is constituted by a separation film/a negative electrode/a separation film/a positive electrode as illustrated in FIG. 8, a positive electrode disposed on an outermost side of an electrode-stacked body is exposed without a separation film. Thus, in this case, a one-side coated positive electrode, an exposed surface of which is not coated with an active material, may be selected as the positive electrode exposed on the outermost side in a capacity-considered electrode design process. Each of electrode unit bodies as illustrated in FIG. 8 has a basic structure, but the present invention is not limited thereto. Thus, an electrode unit body may be formed by stacking two or more basic structures.

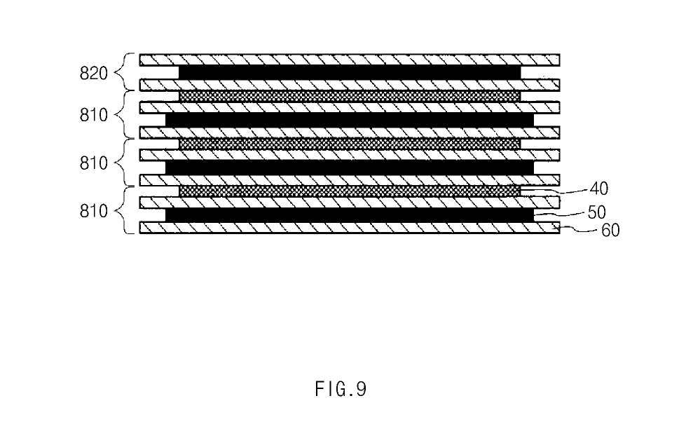

Referring to FIG. 9, an electrode-stacked body is formed by stacking electrode unit bodies 810 having a basic structure of a separation film 60/a negative electrode 50/a separation film 60/a positive electrode 40, and an electrode structure 820 having a structure of a separation film 60/a negative electrode 50/a separation film 60. When the electrode structure having the structure of the separation film 60/the negative electrode 50/the separation film 60 is placed on an outermost surface of a unit cell, a positive electrode 40 is prevented from being exposed to the outside, and electric capacity is increased. In a similar manner, when a negative electrode is disposed on an outermost side of an electrode unit body, an electrode structure having a structure of a separation film/a positive electrode/a separation film may be placed on the negative electrode. In this case, the capacity of the negative electrode is maximally used.

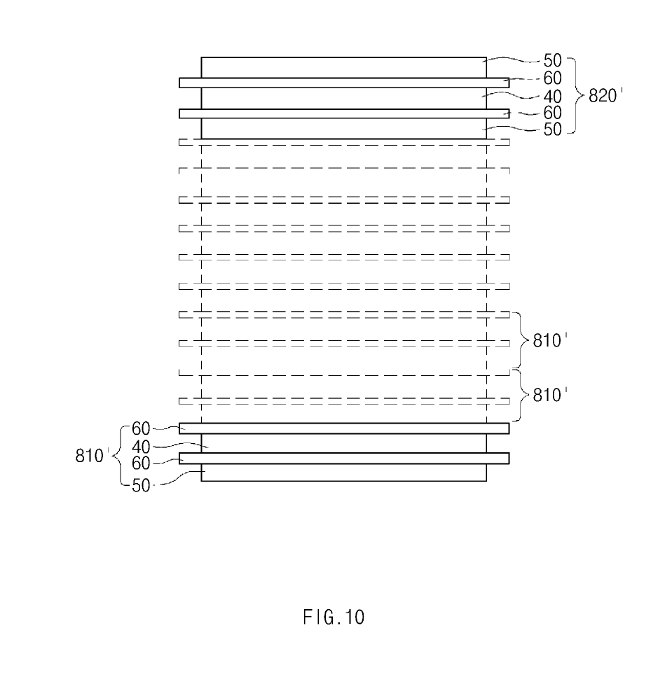

Referring to FIG. 10, an electrode-stacked body is formed by stacking electrode unit bodies 810′ having a basic structure of a negative electrode 50/a separation film 60/a positive electrode 40/a separation film 60/, and an electrode structure 820′ having a structure of a negative electrode 50/a separation film 60/a positive electrode 40/a separation film 60/a negative electrode 50. When the electrode structure 820′ having the structure of the negative electrode 50/the separation film 60/the positive electrode 40/the separation film 60/the negative electrode 50 is placed on an outermost surface of the electrode-stacked body, a positive electrode is prevented from being exposed to the outside, and electric capacity is increased.

Electrode-stacked bodies manufactured in the lamination and stack manner as illustrated in FIGS. 9 and 10 may include a combination of electrode unit bodies having the above-described basic structures, and a single electrode, a separation film, or unit cells having a different array and a different configuration from those of the electrode unit bodies. Specifically, when the electrode unit bodies having the basic structures are stacked, a single electrode, a one-side coated electrode, a separation film, or unit cells having a different array and a different configuration from those of the electrode unit bodies may be disposed on a side surface for preventing a positive electrode from being exposed to the outside and/or on at least one of both outermost surfaces of the electrode-stacked body for increasing battery capacity. Referring to FIGS. 9 and 10, an electrode structure having a different structure is disposed in the upper part of an electrode-stacked body, but the present invention is not limited thereto. Thus, if necessary, an electrode structure having a different structure may be disposed in the lower part of an electrode-stacked body, or in the upper and lower parts thereof.

The wording “stack and folding” commonly means manners in which electrode-stacked bodies formed by stacking a single electrode and/or at least one positive electrode, a separation film, and negative electrodes are disposed on a long sheet type separation film, and then, the long sheet type separation film is folded. In this case, the folding of the sheet type separation film is not specifically delimited, and thus, widely known various folding methods may be used. For example, the widely known various folding methods may include: a method of folding a sheet type separation film in a zigzag shape (referred to as a Z-folding type folding method or a folding screen type folding method); a method of disposing electrode-stacked bodies, formed by stacking at least one negative electrode and a positive electrode with a separation film therebetween, on a surface of a sheet type separation film, and then, winding the sheet type separation film; and a method of alternately disposing single electrodes on both surfaces of a sheet type separation film, and then, winding the sheet type separation film. For convenience in description herein, a unit cell manufactured in the jelly-roll manner is referred to as a jelly-roll type unit cell, a unit cell manufactured in the stack manner is referred to as a stack type unit cell, and a unit cell manufactured in the stack and folding manner is referred to as a stack and folding type unit cell.

In an electrode assembly according to the present invention, two or more types of electrode units having different areas are stacked to form a stepped part, thereby varying the shape of a battery, compared with the related art. A difference between the areas of the electrode units is not specifically delimited, provided that when the electrode units are stacked, the stepped part is formed. Thus, the difference is freely adjusted according to a desired design of the battery. For example, when an electrode assembly according to an embodiment of the present invention includes two electrode units having different areas, an area ratio of the electrode unit having a smaller area to the electrode unit having a greater area may range from about 20% to 95%, preferably, from about 30% to 90%.

According to the present invention, the thicknesses of electrode units of an electrode assembly are not specifically delimited and may be thus the same or different. For example, the thickness of an electrode unit having a relatively large area may be smaller or greater than that of an electrode unit having a relatively small area.

In an electrode assembly according to the present invention, electrodes having different poles are opposite to each other at an interface between electrode units having different areas, so that electricity can be stored even at the interface between the electrode units, thus increasing electric capacity. The term “opposite” means a direction in which the electrodes face each other. In this case, the two electrodes may be opposite to each other without contacting each other, and components, for example, a separation film and/or a sheet type separation film may be disposed between the two electrodes.

The electrode units of the electrode assembly may include at least one electrode tab. When an electrode unit is constituted by a single electrode, the electrode unit may include only one electrode tab. When an electrode unit is constituted by a unit cell, the electrode unit may include both a positive electrode tab and a negative electrode tab. Each of the electrode tabs is electrically connected to electrodes having the same pole. The area and array position of the electrode tabs are not specifically delimited. A portion of the electrode tabs may be taped in order to protect the electrode tabs or further expose the electrode tabs to the outside.

Electrode tabs provided, respectively, on electrode units according to the present invention may have the same area or different areas. Since electrode units included in an electrode assembly have the same area in the related art, electrode tabs having the same area are generally used. However, since an electrode assembly according to the present invention includes two or more types of electrode units having different areas, electrode tabs optimized according to the electrode units may have different areas. Thus, according to the present invention, electric capacity of an electrode assembly can be maximized more efficiently by selecting electrode tabs having different areas according to the areas of electrode units.

The electrode tabs may be disposed in various positions. For example, at least one part of electrode tabs having the same pole may overlap each other. In the related art, all electrode tabs having the same pole generally overlap each other in order to facilitate electric connection of the electrode tabs after an electrode assembly is inserted in a battery case. However, when the number of stacked electrodes is increased, the thickness of the electrode tabs increases, which may deteriorate bonding property between the electrode tabs. When only one part of electrode tabs overlap each other, the deterioration of the bonding property can be significantly mitigated.

Specifically, when an electrode assembly according to the present invention includes two or more types of electrode units having different areas, electrode tabs have different areas according to the areas of the electrode units, and only one part of the electrode tabs overlap each other, thereby maximizing electric capacity and improving the bonding property between the electrode tabs.

The shape of a stepwise electrode assembly according to the present invention is not specifically delimited, but electrode areas may increase or decrease in a direction perpendicular to a plane. Alternatively, the stepwise electrode assembly may have a stacking form such that the electrode areas may decrease or increase from the central part of the stepwise electrode assembly to the outside. As such, a stacking form of an electrode assembly 1 may be regular to have a predetermined pattern, or be irregular, and is thus not specifically delimited.

A battery cell of a lithium ion secondary battery or a lithium ion polymer secondary battery may be manufactured by using an electrode assembly according to the present invention. In this case, the electrode assembly may be installed in a battery case that may be a pouch type case.

The pouch type case may be formed from a laminate sheet. In this case, the laminate sheet may include an outer resin layer on the outermost side thereof, a blocking metal layer for preventing penetration of a material, and an inner resin layer for sealing, but the present invention is not limited thereto.

The battery case may have a structure in which an electrode lead for electrically connecting electric terminals of electrode units of the electrode assembly is exposed to the outside. Although not shown, an insulating film may be attached to upper and lower surfaces of the electrode lead to protect the electrode lead.

The battery case may have a shape that corresponds to the shape of the electrode assembly and that may be formed by deforming the battery case. The shape and size of the battery case may not be completely identical to those of the electrode assembly, provided that inner short circuiting caused by a slip of the electrode assembly can be prevented. However, the shapes of battery cases according to the present invention are not limited thereto, and thus, battery cases having various shapes and sizes may be used if necessary.

Furthermore, a battery pack including two or more battery cells including electrode assemblies according to the present invention may be obtained, and a device including one or more of the battery cells may be obtained. The device may be a cellular phone, a portable computer, a smart phone, a smart pad, a netbook, a light electronic vehicle (LEV), an electric vehicle, a hybrid electric vehicle, a plug-in hybrid electric vehicle, or a power storage device.

1. An electrode assembly comprising:
at least one positive electrode coated with a positive electrode active material on both surfaces of a positive electrode current collector; and at least one negative electrode coated with a negative electrode active material on both surfaces of a negative electrode current collector,
wherein the at least one positive electrode and the at least one negative electrode are alternately stacked in a direction perpendicular to a plane by placing a separation film between the positive electrode and the negative electrode,
the electrode assembly includes a stepped part formed by placing a second electrode, which has a different pole and a different area from those of a first electrode, on the first electrode, and more than two types of electrode tabs having different areas according to the areas of the first electrode and the second electrode, only one part of the electrode tabs overlap each other,
at least one of outermost electrodes located on both surfaces of the electrode assembly is a one-side coated negative electrode, which has a surface coated with the negative electrode active material, and another surface as a non-coated portion, and
the non-coated portion is arranged in order to face the outside of the electrode assembly.

2. The electrode assembly of claim 1, wherein one of the first and second electrodes, which has a greater area than that of the other, is the negative electrode.

3. The electrode assembly of claim 1, comprising at least two electrode units including: a single electrode; at least one unit cell including at least one positive electrode, at least one negative electrode, and at least one separation film; or a combination thereof.

4. The electrode assembly of claim 3, wherein the unit cell is selected from the group consisting of a jelly-roll type unit cell, a stack type unit cell, a lamination and stack type unit cell, and a stack and folding type unit cell.

5. The electrode assembly of claim 3, having a structure in which at least one part of the single electrode and the unit cell, which constitute the electrode units, is surrounded by at least one long sheet type separation film.

6. The electrode assembly of claim 3, wherein electrodes disposed on both outermost surfaces of the unit cell have the same pole.

7. The electrode assembly of claim 3, wherein electrodes disposed on both outermost surfaces of the unit cell have different poles.

8. The electrode assembly of claim 3, wherein electrodes are stacked such that areas of the electrodes increase or decrease in the direction perpendicular to the plane, so as to form a stepped part.

9. The electrode assembly of claim 3, comprising two or more types of electrode units having different areas.

10. The electrode assembly of claim 1, wherein an outermost electrode of the electrode assembly is a one-side coated positive electrode that has a surface coated with the positive electrode active material, and another surface as a non-coated portion, and the non-coated portion is arranged in order to face the outside of the electrode assembly.

11. The electrode assembly of claim 1, comprising three or more types of electrode units having different areas.

12. A secondary battery comprising the electrode assembly of claim 1.

13. The secondary battery of claim 12, wherein the electrode assembly is installed in a battery case.

14. The secondary battery of claim 12, wherein the battery case comprises a pouch type case.

15. The secondary battery of claim 12, comprising a lithium ion secondary battery or a lithium ion polymer secondary battery

16. A battery pack comprising the secondary battery of claim 12 at least in duplicate.

17. A device comprising the secondary battery of claim 12 or the secondary battery of claim 12 at least in duplicate.

18. The device of claim 17, comprising a cellular phone, a portable computer, a smart phone, a smart pad, a netbook, a light electronic vehicle (LEV), an electric vehicle, a hybrid electric vehicle, a plug-in hybrid electric vehicle, or a power storage device.
